(19) United States
(12) Patent Application Publication
(10) Pub. No.: US 2007/0032989 A1
(43) Pub. Date: Feb. 8, 2007

(54) Managing information collected in real-time or near real-time, such as sensor information used in the testing and measurement of environments and systems

(76) Inventors: Mark E. Hodges, Boise, ID (US); Layne Simmons, Middleton, ID (US)

Correspondence Address: PERKINS COIE LLP;PATENT-SEA, P.O. BOX 1247, SEATTLE, WA, 98111-1247, US

(21) Appl. No.: 11/325,614

(22) Filed: Jan. 3, 2006

Related U.S. Application Data
(60) Provisional application No. 60/700,976, filed on Jul. 20, 2005.
(60) Provisional application No. 60/731,920, filed on Oct. 31, 2005.

(51) Int. Cl. G06F 11/00; G06F 15/00

(52) U.S. Cl. 702/188

(57) ABSTRACT

A facility for managing information collected from remote sources, such as remote telemetry devices, is provided. The facility may allow for the configuration of information collection schemes that enable users to customize how the collected information is managed. For example, the facility may allow the user to set rules, specify parameters, and set thresholds that apply to the collection and/or presentation of the collected information. Through the use of data agents or the like, the facility may allow for the concurrent use of multiple remote device types having different platforms. The facility may also allow for the collection and/or aggregation of information originating from multiple distinct environments.

### CROSS-REFERENCE TO RELATED APPLICATION

This application claims priority to commonly-owned U.S. Provisional Patent Application No. 60/700,976, filed Jul. 20, 2005, and commonly-owned U.S. Provisional Patent Application 60/731,920, filed Oct. 31, 2005, which are incorporated by reference in their entirety.

### STATEMENT REGARDING FEDERALLY SPONSORED RESEARCH

This invention was made with government support under contract number NNJO4JA27C awarded by the National Aeronautics and Space Administration. The government may have certain rights in the invention.

### TECHNICAL FIELD

The following disclosure relates generally to managing information relating to measurement and testing of environments and systems, and more specifically to managing such information when collected in real-time or near real-time.

### BACKGROUND

Remote monitoring of information associated with individuals, systems, and/or environments of interest can be important in almost any context, including commercial contexts (e.g., mobile business applications, asset management, product development and testing, field service management, etc.), scientific contexts (e.g., health care, environmental research, animal research, space exploration, etc.), and other contexts (e.g., sports, recreation, military/defense, etc.). Recent advancements in technology have produced remote monitoring devices that can reliably be placed in uncontrolled environments for significant periods of time. For example, such devices may be used to track migratory and home range movements of animals (e.g., location, temperature, motion, battery level, heart rate, noise, reactions, etc.). They can also be used to track the status of a vehicle (e.g., a land vehicle, aircraft, spacecraft, etc.). In another example, remote monitoring devices are used to monitor physiological conditions in living systems (e.g., humans, animals, birds, fish, trees, etc.).

In some cases, such remote monitoring devices often fall into the category of telemetry devices because of their associated data transmission capabilities. For example, such devices may be configured to transmit collected information to one or more data collection systems located apart from the individual, system, or environment of interest. In this way, humans, or even automated processes, can ultimately access and consume the collected information. Such data transmission capabilities are especially useful in cases where it may be difficult (or impossible) to retrieve a monitoring device once it has been placed within the individual, system, or environment of interest (e.g., in the case of space exploration). In current systems, telemetry data collection and similar data collection techniques typically rely on source-specific tools and processes for collection and reporting.

### BRIEF DESCRIPTION OF THE DRAWINGS

FIG. 1 is a block diagram showing an example of an environment in which a facility for managing information collected from remote sources may be implemented in some embodiments.

FIG. 2 is a block diagram showing a, more detailed view of the translation module of FIG. 1 in some embodiments.

FIGS. 3A and 3B are flow diagrams showing sample routines associated with the translation module of FIGS. 1 and 2.

FIGS. 4A and 4B are flow diagrams showing sample routines associated defining and applying rules to data collected by remote monitoring devices in some embodiments.

FIG. 5 is a display diagram showing an example of a rule as applied to information collected by the facility.

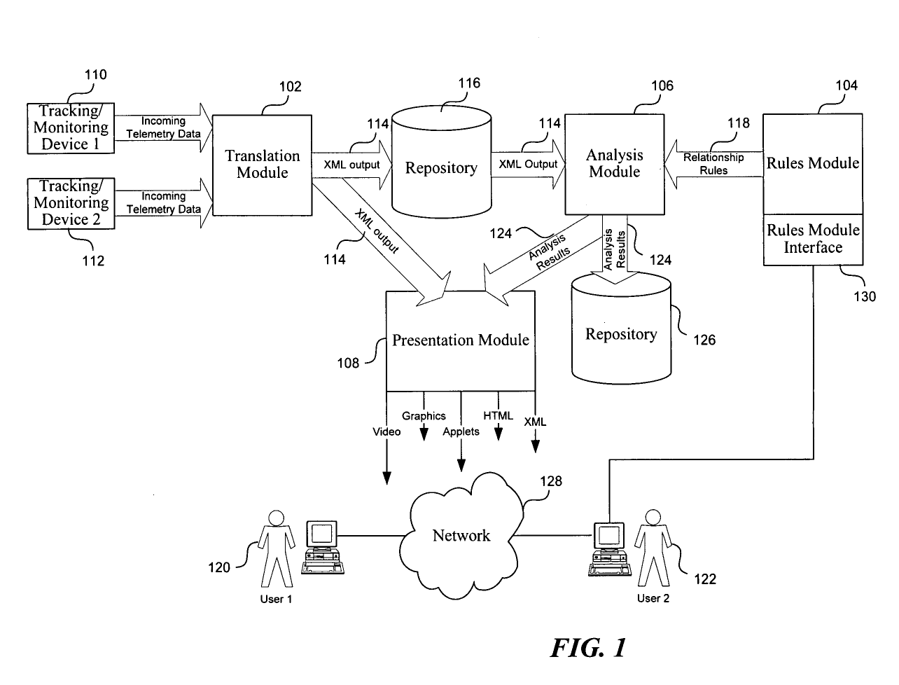

In the drawings, the same reference numbers identify identical or substantially similar elements or acts. To facilitate the discussion of any particular element or act, the most significant digit or digits in a reference number refer to the figure number in which that element is first introduced (e.g., element 104 is first introduced and discussed with respect to FIG. 1).

A portion of this disclosure contains material to which a claim for copyright is made. The copyright owner has no objection to the facsimile reproduction by anyone of the patent document or patent disclosure (including Figures), as it appears in the Patent and Trademark Office patent file or records, but reserves all other copyright rights whatsoever.

### DETAILED DESCRIPTION

Aspects of the invention will now be described with respect to various embodiments. The following description provides specific details for a thorough understanding of, and enabling description for, these embodiments. However, one skilled in the art will understand that aspects of the invention may be practiced without these details. In other instances, well-known structures and functions have not been shown or described in detail to avoid unnecessarily obscuring the description of the embodiments described herein.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

A software facility (or system) is described herein that provides sufficient abstraction to allow real-time or near real-time data received from multiple sources (e.g., remote monitoring devices having different capabilities and/or platforms) to be integrated for automated (or at least partially automated) analysis, presentation, and/or reporting. The facility also provides a way for the received data to be correlated for the purposes of detecting and reporting user-specified events of interest. In addition, information intended for consumption by a user may be presented on devices of different types. In this way, a user (or group of users) is not limited to viewing monitored and/or tracked information from a single device (e.g., an office desktop computer). Instead, the user may switch to multiple devices (e.g., handheld field device, etc.), either automatically, or simply by providing a few data parameters. For example, the facility may be employed to provide remote access of military mission information to interested and privileged personnel at remote locations using web-based technologies. In this particular example, the facility delivers select mission-essential information (e.g., information received from multiple remote monitoring devices) in near real-time to distributed users (e.g., over a wireless communications infrastructure with transient connectivity).

On the data collection/translation side, the facility may be configured to handle multiple types of input data from multiple types of tracking and monitoring devices. Through the use of information rules and similar techniques, users of the facility may be able to specify and configure the way that the facility and/or the remote monitoring device(s)) collect and handle such data, even after the remote monitoring devices have been deployed into the individual, system, or environment of interest. In this way, the facility's information rules allow the user to specify rules about information generation. In addition, the facility may allow users to quickly prioritize and reprioritize the data collected by the remote monitoring devices. The facility may also include mechanisms so that the remote monitoring devices can be controlled remotely, from the facility. U.S. patent application Ser. No. ______, filed Jan. 3, 2006, entitled SYSTEMS AND METHODS FOR USE IN REMOTE DATA COLLECTION, SUCH AS FOR USE WITH ATMOSPHERIC DATA COLLECTION DEVICES (Attorney Docket No. 571788002US1), which is incorporated by reference.

On the data presentation side, the facility may be configured to allow users to efficiently view information of specific interest in real-time or near real-time from a variety of user-devices (e.g., personal computers, laptops, handheld devices including mobile phones, PDAs, etc.). Through the use of presentation rules and similar techniques, the facility may allow users to manipulate the way that the collected data is organized and/or presented. The facility may be configured so that a user may accomplish setting and resetting of rules (including both information rules and presentation rules) with little or no interruption of the facility's data collection, data access, and data presentation functionality.

II. Sample System Architecture

FIG. 1 and the following discussion provide a brief, general description of a suitable environment in which the facility can be implemented. Although not required, aspects of the facility are described in the general context of computer-executable instructions, such as routines executed by a general-purpose computer (e.g., a server computer, wireless device, or personal/laptop computer). Those skilled in the relevant art will appreciate that the invention can be practiced with other communications, data processing, or computer system configurations, including Internet appliances, hand-held devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, mini-computers, mainframe computers, and the like.

Aspects of the facility can be embodied in a special purpose computer or data processor that is specifically programmed, configured, or constructed to perform one or more of the computer-executable instructions explained in detail herein. Aspects of the facility can also be practiced in distributed computing environments where tasks or modules are performed by remote processing devices, which are linked through a communication network. In a distributed computing environment, program modules may be located in both local and remote memory storage devices.

Aspects of the facility may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the invention reside on a server computer, while corresponding portions reside on a client computer, such as a mobile device.

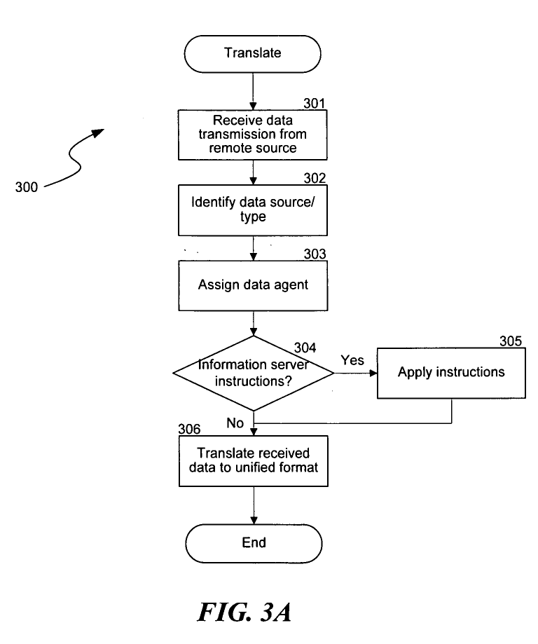

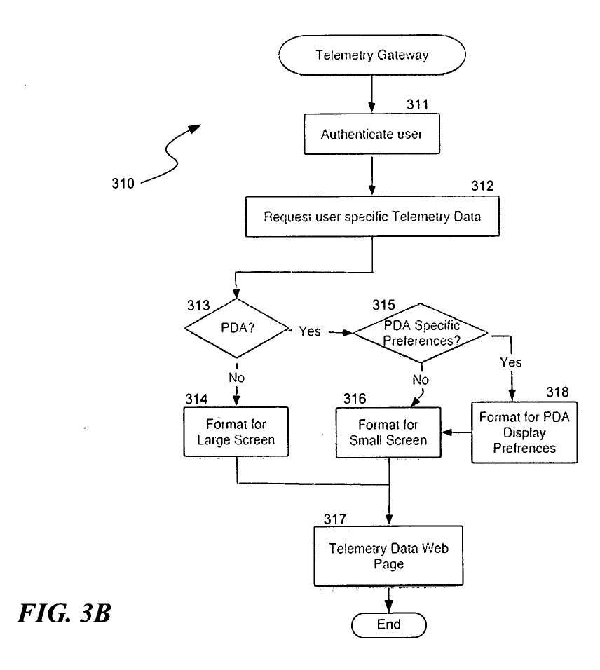

Referring to FIG. 1, the facility consists of several modules including a translation module 102, a rules management module 104, an analysis module 106, and a presentation module 108. In some embodiments, the translation module 102 is responsible for extracting real-time data from remote monitoring devices 110 and 112, which may each have source-specific formats and protocols. For example, remote monitoring device 110 may originate from a first vendor and remote monitoring device 112 may originate from a second vendor; and therefore, device 110 may be configured very differently than device 112 (e.g., different platforms, different applications, different data formats, etc.). Accordingly the translation module 102 may be at least partially responsible for handling the discrepancies between the tracking and monitoring devices 110 and 112 (e.g., by translating their received output into XML or another unifying format). This translation activity produces output 114 that humans and/or machines can read without using device- or vendor-specific tools. In some embodiments, the translation module 102 may perform multiple translations (e.g., in series or in parallel) depending on the operational environment. The facility may store output from the translation in a repository 116. Alternatively the output may be accessed directly by the analysis module. As discussed in more detail with respect to FIG. 3B, aspects of the translation module may also be useful in formatting data for output to various in a way that allows them to be easily consumed on particular devices or in accordance with particular user display preferences.

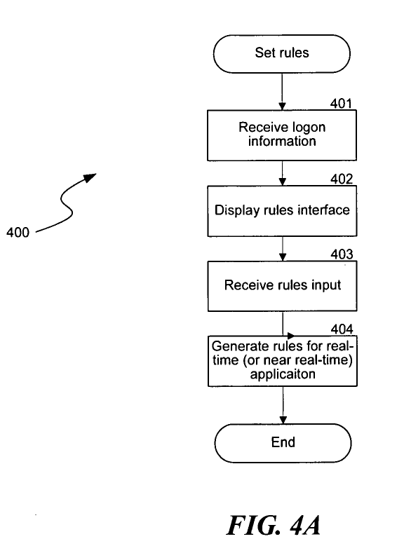

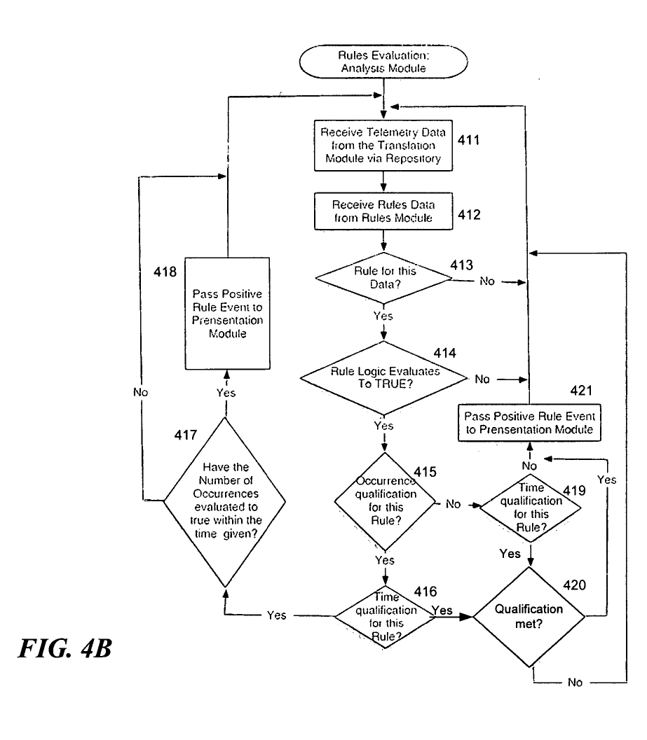

The rules management module 104 allows users (e.g., users 120 or 122) to define rules 118 relating to the logical relationships between various data elements derived from data collected by the remote monitoring devices 110 and 112, without regard to its source (e.g., device 110 verses device 112). In some embodiments, users may access the rules module (e.g., to specify parameters, thresholds, operational scenarios, etc.) via a rules module interface 130. An example of a rule definition/configuration process is described in more detail with respect to FIG. 4A.

In some embodiments, the facility uses these user-specified rules 118 as input to the analysis module 106. The analysis module 106 is responsible for interpreting the rules 118 of the rules management module 104 and applying underlying rule logic to the output 114 of the translation module 102. The results 124 of the analysis may be stored in a repository 126 and may result in the facility generating alerts (e.g., machine-generated e-mail messages) to send to users for notification purposes. An example of this process is described in more detail with respect to FIG. 4B.

The presentation module 108 makes use of the outputs of the translation and/or analysis modules (114 and 124, respectively) to create an instance of an interface (e.g., a web-based tool) for viewing data and analysis results. This provides the facility's users (e.g., 120 and 122) with a mechanism by which all data and analysis results can be viewed or referenced from any suitable user device residing on one or more networks 128, including personal computers, wireless devices such as cell phones and PDAs, tablet computers, etc. The presentation module 108 may be configurable so that it organizes and presents information in a way that is most useful to any given user. In some embodiments, the presentation module 108 is also capable of making intelligent choices about how data should be displayed based on information about the user device without requiring advance configuration or user input.

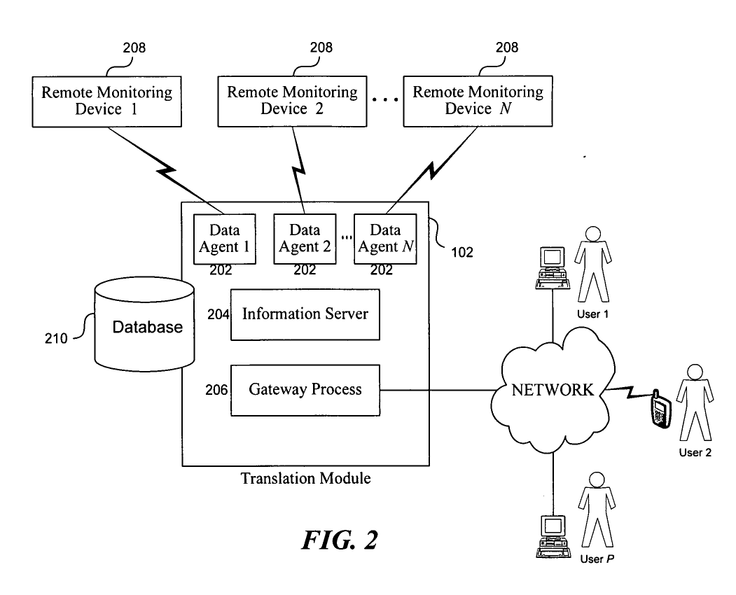

Referring to FIG. 2, in some embodiments, the translation module 102 comprises multiple conceptual subcomponents including multiple data agents 202, an information server 204, and a gateway process 206. To support collecting data (e.g., telemetry data) from a variety of remote monitoring devices 208 in a variety of environments, each of the data agents 202 may be specific to a particular operational environment or remote monitoring device 208 and, thus, serve as a primary point of abstraction for data received from a corresponding remote monitoring device 208. Accordingly, in some embodiments, the data agents 202 take-in telemetry data (or the like) in a source-specific way. In some embodiments, each of the data agents 202 then emits a human-readable, well-structured data stream for consumption by various clients, which may or may not include additional components of the translation module 102. There may also be inherent value in the raw output of the data agents 104, as each produces a source-independent representation of telemetry data.

In some embodiments, the information server 204 functions as a general arbiter for the delivery of data from the data agent(s) 202. More specifically, the information server 204 may provide a means by which an application or user process may request specific telemetry data (or the like). For example, if a user requests to receive information about a certain type of parameter, the data agent can learn about this request from the information server 204 and, in response, transform the data in a way that allows this parameter to be efficiently extracted from its output. In this way, the user is presented only with information that he or she finds relevant/important. The information server 204 may include mechanisms to remotely control the tracking/monitoring devices.

In some embodiments, the gateway process 206 is a software agent for users of the facility—it requests selective sets of telemetry from the information server 204 and delivers it to a database 210. A more detailed example of a routine performed by the gateway process 206 is described with respect to FIG. 3B. In addition, the gateway process 206 may own the task of analyzing the telemetry streams in the context of user-specific rules that define events of interest. Should an event of interest be detected, the gateway process 206 may perform the appropriate notification activities.

III. System Flows

FIGS. 3A, 3B, 4A, and 4B are representative flow diagrams that show processes that occur within the systems of FIGS. 1 and 2. These flow diagrams do not show all functions or exchanges of data but, instead, provide an understanding of commands and data exchanged under the system. Those skilled in the relevant art will recognize that some functions or exchanges of commands and data may be repeated, varied, omitted, or supplemented, and other aspects not shown may be readily implemented. For example, while not described in detail, a message containing data may be transmitted through a message queue, over HTTP, etc.

FIGS. 3A and 3B show routines associated with the translation module 102 described with respect to FIGS. 1 and 2. More specifically, FIG. 3A shows an example of a routine performed in association with the information server 204 and FIG. 3B shows an example of a routine associated with the gateway process 206.

Referring to FIG. 3A, a flow diagram shows an example of a routine 300 for translating information received (e.g., via telemetry) from remote monitoring devices. At block 301, the routine 300 receives information from a remote monitoring device. For example, given a heart rate factor sampled fifty-times a second and a motion data factor sampled sixty-four times a second, the corresponding data may be sent from the remote monitoring device at the rate of one transmission per second, or at some other frequency, which, in some embodiments, may be configured by the user. Where the most up to date data is desired, the user may set the frequency of transmissions from the remote monitoring device at a very high rate. In other cases, the user may set the frequency of transmissions from the telemetry at a much lower rate to conserve battery power at the telemetry device, conserve bandwidth use, etc. The amount of data sent in each transmission may be small or very large (e.g., containing hundreds of thousands of parameters). Various protocols may be used for transmitting/distributing telemetry data including, for example, Information Sharing Protocol (ISP), ISPX (which employs VPN technology), or other protocols that support real-time or near real-time information distribution in a distributed heterogeneous environment.

At block 302, the routine 300 identifies a source of the received data so that an appropriate data agent may be assigned (block 303) (e.g., based on type of remote monitoring device or environment). At decision block 304, the routine 300 checks for instructions from the information server 204 that provides a means by which an application or user process may request specific data from the remote monitoring device after the receipt of initial information. At decision block 304, if there are instructions from the information server 204, the routine 300 continues at block 305 to apply those instructions (e.g., instructions requesting that additional information be provided by the remote monitoring device); otherwise, the routine 300 continues at block 306 where the assigned data agent emits a human-readable, well-structured data stream for consumption by clients (e.g., an XML output). The routine 300 ends after block 305. While the routine described above (and other routines provided as examples in this Detailed Description) discuss receiving data from a single remote monitoring device, as mentioned above, the facility may simultaneously collect information from multiple remote monitoring devices, and may even include capabilities for integrated such information into a collection of related information.

FIG. 3B is a formatting routine 310 performed in association with the gateway process 206 of FIG. 2. At block 311, the routine 310 authenticates the user. At block 312, the routine 310 requests user-specific telemetry-data (e.g., an indication of a custom data set which the user would like to receive). For example, a user may indicate to the facility that he or she wants to receive telemetry information related to a bird's movement in a north/south direction, but does not wish to receive telemetry information related to the bird's movement in an up/down direction.

In response to the request, the routine 310 receives the requested data, but it may still need to perform device-specific formatting before it can pass this data on to the user. Accordingly, at decision block 313, the routine 310 determines whether the telemetry device will be sending information to a small form factor device, such as a personal digital assistant (PDA), smart mobile phone, or other handheld device. If the device is a small form factor device, the routine 310 continues at decision block 316. Otherwise, the routine 310 proceeds at block 314, where the routine 310 formats the data for a standard size computer screen.

At decision block 316, the routine 310 checks whether the user has provided specific formatting preferences (e.g., presentation rules) for the small form factor device. If no specific formatting requirements exist, the routine 310 continues a block 316 to format the data for a generic small screen device. If, however, at decision block 315 the user has provided specific formatting preferences, at block 318, the routine 310 formats the data according to the provided preferences After formatting (block 314, 316, or 318) the routine 310 continues at block 317 to provide a web page (or other interface) that presents the requested telemetry data. The routine 310 then ends.

FIG. 4A is a flow diagram showing an example of a routine 400 associated with setting parameters to be applied as rules by the facility. For example, the facility may have the ability to subscribe to data elements (e.g., measurement stimulus identifications (MSIDs)), to set thresholds (including high, low, and discrete) and individual parameters, and present the resulting data in real time or near real-time. To facilitate these processes, the facility may allow users to input configuration parameters, which the facility can then implement and apply as information rules (e.g., via the rules module 104 of FIG. 1) to prioritize and relate data together for viewing depending on pre-determined event thresholds.

At block 401, to configure the facility, a user with the appropriate authority (e.g., an administrative user) logs on to access a rules module through a web interface. The interface of the rules module may include one or more user and/or group configuration screens, displayed by the routine 400 at block 402. One or more of these screens enable the user to add parameters and associated thresholds that the user is interested in tracking. One level of configuration allows the user to define complex relationships among data elements that are to be tracked. For example, the user may specify that he or she is interested in two pressure values (Pa and Pb) and two valves (V1 and V2), but that he or she wants to see the pressure data only under the conditions 100<Pa<151 AND 125.5<Pb<138.8 AND V1=open AND V2=closed. Accordingly, at block 403, the routine 400 receives rule definitions from the user. At block 404, the routine 400 transforms the definition into one or more rules that can be applied (e.g., via the analysis module 106 of FIG. 1) near the time that the data is received.

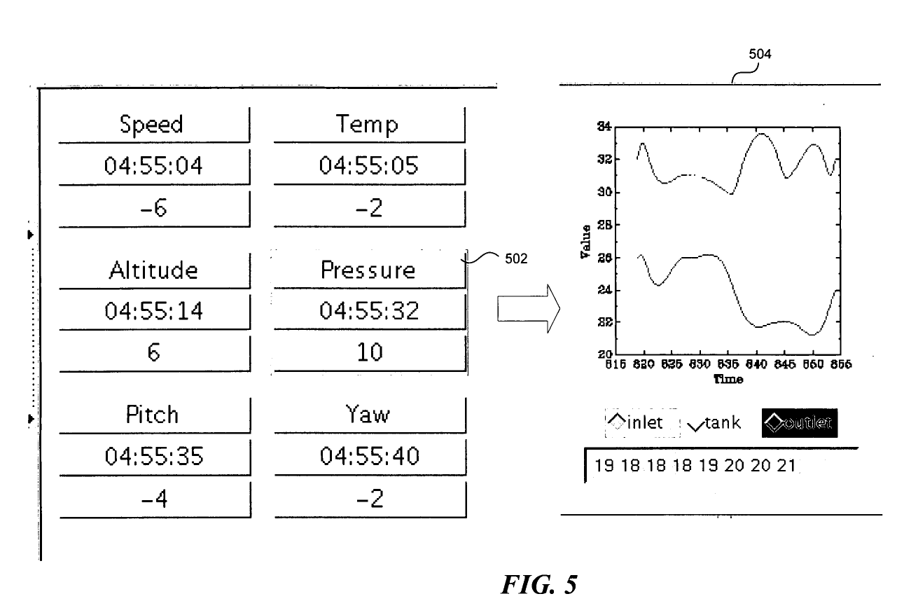

Additional rules relating to thresholds may include rules that specify certain display paths to follow if the thresholds are met. For example, a user may specify that if a threshold is met, the facility should show a graphical data history (e.g., history of most recent fifteen minutes of activity). An example of this is shown in FIG. 5, where a pressure value 502 is shown to exceed a given threshold, resulting in the display of a several minutes of graphical history 504. Likewise, the user may specify that if a threshold is met, the facility should display additional related data parameters or send an alert to a group or individual.

Another type of configuration includes defining presentation rules that determine which users can view certain information. For example, users from one group may not have the same access to information as users from another group. In this way, the facility can be configured so that each user receives information that is the most relevant to him or her. For example, a tabular interface may allow an administrative user to configure groups of users, and then to define the information that will be available to each group. From this, the facility automatically generates a set of presentation rules that is applied to incoming data. In some embodiments, a second level of configuration applying to groups and/or individuals includes, defining a specific data set that users can view (e.g., on a portable device) when away from a primary data viewing location. For example, if six data parameters are of interest to a user while they are away at a meeting, this data set, along with appropriate thresholds and actions, enable the user to watch a subset of the data of interest to them.

FIG. 4B is a flow diagram showing a routine 410 for applying a rules-based analysis to enforce the parameters provided by the user relating to what type of data the user wishes to be presented with. As described above, the facility may apply the rules set configured by the user to translated telemetry data (or the like) via an analysis module, such as the analysis module of FIG. 1. Accordingly, the routine 410 may be performed by the analysis module, which applies defined rules to incoming data as needed. At block 411, the routine 410 receives translated/formatted telemetry data from the translation module 102, e.g., via an information repository. At block 412, the routine 410 receives rules data from the rules module. At decision block 413, the routine 410 checks to see whether there is a rule to apply to the received telemetry data. If not, the routine 410 loops back to the beginning of the routine 410 to receive the next set of telemetry data. If, however, at decision block 413, the rules data does contain an applicable rule, the routine 410 proceeds to block decision block 414 to apply the rule to the data and determine whether the rule is satisfied (e.g., the rule logic evaluates to true). If the rule is not satisfied, the routine 410 loops back to the beginning of the routine 410 to receive the next set of telemetry data. If, however, at decision block 414, the rule is satisfied, the routine 410 proceeds to decision block 415, where the routine 410 determines whether an occurrence qualification applies to the rule. In some embodiments, the occurrence qualification may specify that a particular activity indicated in the telemetry data should occur a certain number of times before it may be presented to the user. For example, if the telemetry device is collecting data associated with monitoring ocean wave period and the rule indicates that the user only wishes to receive data when wave period changes, data indicating a that a wave is coming in at a shorter or longer period may have to present itself more than once to accurately signify an actual change in wave period. Accordingly the occurrence qualification may indicate that a change in wave period would have to occur more than once before corresponding data is to be presented to the user.

If, at decision block 415, occurrence qualifications apply, the routine 410 continues at decision block 416, where it determines if time qualifications apply. For example, using the wave period scenario provided above, more than one occurrence of a changing wave period may have to take place within a specified time frame (e.g., 3 times in ten minutes) to satisfy both the occurrence and the time qualifications. Accordingly, if time qualifications do exist, the routine 410 proceeds from decision block 416 to decision block 417, to determine whether the number of occurrences meet the time qualifications. If time qualifications do not exist, the routine 410 proceeds from decision block 416 to decision block 420 to determine if the occurrence qualifications (applied in the absence of time qualifications) exist.

Likewise, if at decision block 415, occurrence qualifications do not apply, the routine 410 continues at decision block 419, to check for time qualifications applied in the absence of occurrence qualifications. For example, if the telemetry device collects information associated with monitoring heart rate, the user may only wish to see heart rate information that occurs at certain times of day (e.g., in the morning). If applicable, the routine 410 determines if the time qualifications are satisfied at decision block 420.

From decision blocks 417 or 420, if respective time/occurrence qualifications are satisfied, the routine 410 continues at either block 418 or block 421 to pass a positive rule event indication to a presentation module so that the appropriate information can be presented to the user. If, however, from decision blocks 417 or 420, if respective time/occurrence qualifications are not satisfied, the overall rule is not satisfied, and the routine 410 loops back to the beginning to receive the next set of telemetry data from the translation module 102.

IV. Sample Implementation Schemes for Software Components

In some embodiments, the facility's functionality is implemented using a combination distributed/distributable software components (e.g., feeder, agent, client) that make use of a number of subordinate/utility components (parameter, device, XMLElement, XMLParserDelegate, rule, etc.). These software components and their subordinate/utility components may be written in a programming language such as C, C++, Objective-C, Java, C#, etc. If implemented in an object-oriented programming framework, the components may be implemented as objects based on corresponding classes. The feeder software component encapsulates attributes and behaviors of a telemetry source. The client software component provides a simple abstraction of a telemetry consumer for use by instances of the feeder software component. The agent software component acts as an object broker, associating telemetry consumers with telemetry sources.

Users of the facility may deliver a telemetry request including parameters to an instance of the agent software component that specifies the type of telemetry desired. The agent attempts to create a feeder instance corresponding to the telemetry type. If the attempt is successful, a client stub is created for the feeder, and the feeder and consumer begin communicating directly. The agent instance maintains a reference to both the feeder and the client stub instances, and is notified if either of them is shutting down. This notification mechanism allows the agent software component to clean up after a telemetry session terminates.

The rule software component wraps up executable logic and applies it to a dictionary of object instances that support an accessor method (e.g., a “value” method). The logic may expressed using the common equality/inequality comparator set (‘=’, ‘˜=’, ‘<’, ‘<=’, ‘>=’, ‘<’).

The client software component may be responsible for evaluating rules as telemetry flows through the system. A dictionary of parameter values is constructed as data comes in from the feeder(s), and the client's rules are evaluated using that dictionary at appropriate intervals (data cycles). The result of the evaluation is a Boolean value (e.g., TRUE or FALSE), which is then left for interpretation by the controlling process.

In some embodiments, the user may be able to configure/customize aspects of the facility's rule processing infrastructure. For example, the user may be able to specify mechanisms (e.g., class name, application name, etc.) and methods (e.g., selector invocations, etc.) used to perform the extended evaluation of data.

The following example provides a sample of XML request used to start a telemetry session in one embodiment.

<?xml version=‘1.0’ standalone=‘yes’?>
<tlmStart telemetryType=‘TXS’>

<tlmRequest uid=‘parameter_unique_id’/>

</tlmRequest>

With respect to the above XML example, the telemetryType attribute is used by the agent software component to create an instance of a feeder software component. For example, the agent software component may create the instance by appending “Feeder” to the telemetryType attribute and using a ClassFromString( ) operation to instantiate the object. The agent then invokes the ClassFromString(@“Feeder”) operation to create the feeder instance. If the ClassFromString( ) operation fails (e.g., returns nil), then the agent will attempt to locate a loadable resource that implements the feeder class that the consumer requires. If no appropriate resource is found, then the agent software component may return an error message to the consumer and drop the connection.

The following example provides a sample of XML reply (e.g., sent in response to the request described above).

<?xml version=‘1.0’ standalone=‘yes’?>
<tlmReply to=‘tlmStart’ result=‘YES’/>

With respect to the above example, if the result attribute is “NO” instead of “YES,” the reply may function as an error message, and the XML may appear as follows:

<?xml version=‘1.0’ standalone=‘yes’?>
<tlmReply to=‘tlmStart’ result=‘NO’>
...
</tlmReply>

The following examples provide samples of XML used to deliver data from the telemetry device.

### EXAMPLE 1

<?xml version=‘1.0’ standalone=‘yes’?>
<tlmDoc device=‘00 50 67 BC 11 9F’ battery=‘85’ signal=‘90’>

<tlmRec uid=‘10’ value=‘72’ time=‘114238560393’/>
...

</tlmDoc>

### EXAMPLE 2

<?xml version=‘1.0’ standalone=‘yes’?>
<tlmDoc device=‘00 50 67 BC 11 9F’ battery=‘85’ signal=‘90’>

<tlmRec>

<sensor>10</sensor>
<value>72</value>
<time>114238560393</time>

</tlmRec>

</tlmDoc>

V. Operational Scenarios and Device-Specific Presentation

The facility may allow users to use rules to define one or more operational scenarios, including a pull scenario, a crawler scenario, a push scenario, and others. In some embodiments, it may be possible to change designated operational scenarios “on the fly.”

In some embodiments, a push scenario allows the user to define and set thresholds for data that they can monitor remotely. For example, the user may specify that a temperature sensor should stay within 75 and 80 degrees Fahrenheit and that if the temperature moves either above or below those values, an alert (e.g., a visual or audio alert) should be sent to the user. Another type of push scenario is dependent on user roles. For example, if a user is a propulsion flight controller, only the information that is deemed important to monitor from a propulsion perspective is “pushed” to the user. In some embodiments, these data sets defining information pushes are predefined and may be changed on the fly.

In some embodiments, a crawler scenario allows a steady stream of parameters (either data or information) to be sent to the user in real-time. For example, this information may provide a nominal “quick look” at a tracked vehicle and show common parameters such as attitude, battery charge state, etc. The incoming information stream may be displayed in an application or view that is hidden by default, or may be configured as a stream of information that is visible across the screen at all times.

In some embodiments, a pull scenario allows the user to access data by request at any time. Based on area of interest (propulsion, mechanical, etc.), the user can navigate through a set of informational screens to access the actual data. In some embodiments, this scenario can be used in conjunction with the push scenario (or other scenario) to allow operators to access additional data if there is an alert.

Examples of additional operational scenarios may include an application that remotes an event log for major events. For example, the event log application may output messages based on an interpretation of input information. Accordingly, in this type of operational scenario, rules set by the user may specify a behavior to take based on an action (e.g., the user programs the application on how to interpret the input data). For example, the event log application may be configured to output the message “APU Fuel Tank Valve 1—Open” when a switch changes from zero to one.

Other operational scenarios (as well as those described above) may include the use of maps, clocks or internal timers output on a data stream, television or video, ISP stream displays, Voice-over-IP, plot drawings, etc.

In general, the various data elements that are sent to the facility are reformatted and produced as text or graphics in an HTML page that a client (e.g., user computer/mobile device) can monitor through the use of, for example, built-in web browsing capability. In some embodiments, this may be performed by a presentation component, such as the presentation module 108 of FIG. 1. To accommodate for multiple client device types, the facility may accept definitions for rules associated with data presentation and modifications of formats depending on device type. For example, if a user is accessing the facility's information screens from a personal computer or laptop, the displayed output can be more rich then one seen on a smaller handheld. In some embodiments, the facility may set some of these rules automatically, depending on the device. For example, the facility may be able to detect if a request for data is coming from a laptop, a hand-held device, or a cell phone, etc., and automatically present the data accordingly.

### CONCLUSION

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the facility is not intended to be exhaustive or to limit the invention to the precise form disclosed above. While specific embodiments of, and examples for, the facility are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number, respectively.

The teachings of the invention provided herein can be applied to other systems, not necessarily the system described herein. The elements and acts of the various embodiments described above can be combined to provide further embodiments.

This application is related to commonly-owned U.S. patent application Ser. No. ______, filed Jan. 4, 2006, entitled SYSTEMS AND METHODS FOR USE IN REMOTE DATA COLLECTION, SUCH AS FOR USE WITH ATMOSPHERIC DATA COLLECTION DEVICES (Attorney Docket No. 571788002US1). All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. As noted above, particular terminology used when describing certain features or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A system for managing information collected from one or more remote sources, including information associated with tracking or monitoring an individual, a system, or an environment, the system for managing comprising:
a translation module configured for receiving information from the one or more remote sources and translating the information to generate at least one output having a unified format, wherein the one or more remote sources include a first remote source having a first device type or platform that transmits information in a first format, and a second remote source having a second device type or platform that transmits information in a second format distinct from the first format;
a rules module configured for receiving definitions for rules to apply to the at least one output of the translation module, wherein the rules include a first set of parameters used in generating the at least one output and a second set of parameters used in analyzing the at least one output;
an analysis module coupled to the rules module, wherein the analysis module includes processing capabilities configured for analyzing the at least one output and applying the rules of the rules module; and
a presentation module configured for presenting the analyzed information, wherein the presentation module provides alternative presentation formats to different devices based on device type.

2. The system of claim 1 wherein the processing capabilities of the analysis module performs correlation on the at least one output for the purposes of detecting and reporting user-specified events of interest.

3. The system of claim 1 wherein the one or more remote sources include telemetry devices.

4. The system of claim 1 wherein the translation module includes a first data agent that handles information from the first remote source and second data agent that handles information from the second remote source.

5. The system of claim 1 further comprising a computer-readable medium comprising a data structure containing instructions for performing a method at the analysis module, wherein the method includes:
determining if at least one of the rules received at the rules module applies to the information received at the translation module; and
if at least one of the rules applies, evaluating the received information based on the at least one rule.

6. The system of claim 1 wherein information is received at the translation module in real-time or near real-time.

7. The system of claim 1 wherein information is received at the translation module in real-time or near real-time and wherein the analyzing and applying associated with the analysis module is performed in real-time or near real time.

8. A method for managing information collected from one or more devices configured to perform sensing activities in an environment, the method comprising:
providing an interface for receiving definitions for rules configured for real time or near time application in association with performing the sensing activities and/or in managing the information collected from the one or more devices;
receiving definitions for rules via the provided interface and storing the received definitions;
receiving information from the one or more devices in real-time or near real-time;
determining, in real-time or near real-time, if at least one of the stored definitions applies to the received information; and
if at least one of the stored received definitions applies, evaluating the received information based on the at least one stored definition.

9. The method of claim 8
wherein the provided interface includes one or more screens that enable a user to add parameters and associated thresholds associated with aspects of the environment that the user is interested in tracking;
wherein the received definitions include a definition of complex relationships among multiple data elements of interest that a user is interested in tracking;
wherein the information is received from the one or more devices via RF transmission, and wherein the one or more devices are telemetry devices; and
wherein evaluating the received information based on the at least one stored definition includes determining whether rule logic associated with the at least one stored definition evaluates to true and determining whether a threshold number of occurrences of a select sensed activity has occurred in a given time period.

10. The method of claim 8 wherein the provided interface includes one or more screens that enable a user to add parameters and associated thresholds associated with aspects of the environment that the user is interested in tracking.

11. The method of claim 8 wherein the received definitions include a definition of complex relationships among multiple data elements of interest that a user is interested in tracking.

12. The method of claim 8 wherein evaluating the received information based on the at least one stored definition includes determining whether rule logic associated with the at least on stored definition evaluates to true.

13. The method of claim 8 wherein evaluating the received information based on the at least one stored definition includes determining whether rule logic associated with the at least one stored definition evaluates to true and determining whether a threshold number of occurrences of a select sensed activity has occurred.

14. The method of claim 8 wherein evaluating the received information based on the at least one stored definition includes determining whether rule logic associated with the at least one stored definition evaluates to true and determining whether a threshold number of occurrences of a select sensed activity has occurred in a given time period.

15. The method of claim 8 wherein evaluating the received information based on the at least one stored definition includes determining whether rule logic associated with the at least one stored definition evaluates to true and determining whether a select sensed activity has occurred within a given time period.

16. The method of claim 8, further comprising passing an indication of a positive evaluation of the received information to a presentation module for presentation at a user device.

17. The method of claim 8 wherein the information is received from the one or more devices via RF transmission, and wherein the one or more devices are telemetry devices.

18. The method of claim 8 wherein the received definitions further include a definition of thresholds that allow a specified information display path to occur when met.

19. The method of claim 8 wherein the received definitions further include a definition of users or groups of users that have permission to view specified information.

20. A method for managing information collected from one or more remote sources, including information associated with tracking or monitoring an individual, a system, or an environment, the method comprising:
receiving telemetry information from a monitoring device, wherein the received telemetry information is in a format dependent on the environment of the monitoring device, the type of the telemetry device, or platform of the telemetry device, or any combination of the environment, type, or platform of the telemetry device;
based on the on the environment of the telemetry device, the type of the telemetry device, or platform of the telemetry device, or any combination of the environment, type, or platform of the telemetry device, identifying the received telemetry information as telemetry information that is best suited for processing by a data agent selected from a set of data agents;
at the select data agent, translating the telemetry information to a format that is not dependent on the environment of the telemetry device, the type of the telemetry device or the platform of the telemetry device; and
generating an output based on the translation.

21. The method of claim 20
wherein the output includes a human-readable, well-structured data stream for consumption by clients, and wherein the output is formatted using Extensible Markup Language (XML);
wherein the translating includes applying instructions requesting that additional information be provided by the remote monitoring device; and
wherein the output is configured for further processing, including the application of user specified rules, parameters, and thresholds.

22. The method of claim 20 further comprising:
receiving additional telemetry information from another remote monitoring device, wherein the additional telemetry information is in format that is different than the format of the received telemetry information; and
handling discrepancies between the received telemetry information and the additional telemetry information to facilitate combining the received telemetry information and additional telemetry information into a single about.

23. The method of claim 20 wherein the output is configured for further processing, including the application of user specified rules, parameters, and thresholds.

24. The method of claim 20 wherein the translating includes applying instructions requesting that additional information be provided by the remote monitoring device.

25. The method of claim 20 wherein the output includes a human-readable, well-structured data stream for consumption by clients.

26. The method of claim 20 wherein the output is formatted in Extensible Markup Language (XML).

27. The method of claim 20, further comprising, in association with translating the telemetry information, applying parameters or thresholds or both parameters and thresholds, to the received telemetry information, wherein the parameters, thresholds, or both parameters and thresholds influence the contents of the generated output.

28. A system for managing information collected from one or more remote sources, including information associated with tracking or monitoring an individual, a system, or an environment, the system for managing comprising:
means for receiving information from the one or more remote sources and translating the information to generate at least one output, wherein the one or more remote sources include a first remote source having a first device type or platform that transmits information in a first format, and a second remote source having a second device type or platform that transmits information in a second format distinct from the first format;
means for receiving definitions for rules to apply to the at least one output of the translation module, wherein the rules include a set of parameters used in analyzing the at least one output;
means for analyzing the at least one output in real-time or near real-time based on applying at least some of the rules of the rules module; and
means for presenting the analyzed information.

29. The system of claim 28 wherein the means for presenting the analyzed information includes means for formatting the analyzed information to be displayed on small form factor devices.

30. The system of claim 28 wherein the means for presenting the analyzed information includes means for formatting the analyzed information according to user preferences.

31. The system of claim 28 wherein the rules further include rules that specify a push operational scenario in which a user defines and sets thresholds for data to be monitored remotely at the remote sources and then pushed to the means for receiving information.

32. The system of claim 28 wherein the rules further include rules that specify a crawler operational scenario in which a steady stream of user-defined parameters is sent to the user in real-time or near real-time.

33. The system of claim 28 wherein the rules further include rules that specify a pull scenario that allows a user to access data on demand.
